(19) United States
(12) Patent Application Publication
(10) Pub. No.: US 2023/0010895 A1
(43) Pub. Date: Jan. 12, 2023

(54) INFORMATION PROCESSING APPARATUS, INFORMATION PROCESSING METHOD, AND COMPUTER-READABLE RECORDING MEDIUM STORING INFORMATION PROCESSING PROGRAM

(71) Applicant: FUJITSU LIMITED, Kawasaki-shi (JP)

(72) Inventors: Shingo OKUNO, Kawasaki (JP); Masahiro Miwa, Kawaguchi (JP)

(73) Assignee: FUJITSU LIMITED, Kawasaki-shi (JP)

(21) Appl. No.: 17/708,020

(22) Filed: Mar. 30, 2022

(30) Foreign Application Priority Data
Jul. 8, 2021 (JP) 2021-113611

(51) Int. Cl. G06F 9/50

(52) U.S. Cl. CPC G06F 9/5038; G06F 9/5072; G06F 9/5077; G06F 2209/505

(57) ABSTRACT

An information processing apparatus includes: a memory; and a processor coupled to the memory and configured to: divide a job in units of computing nodes for a plurality of computing nodes; determine execution of scale-out or scale-in on the basis of a load in a case where each of the computing nodes is caused to execute a job obtained by the division; execute, in a case where determining execution of the scale-out, the scale-out according to the division of the job in units of computing nodes; and execute, in a case where determining execution of the scale-in, the scale-in according to the division of the job in units of computing nodes.

### CROSS-REFERENCE TO RELATED APPLICATION

This application is based upon and claims the benefit of priority of the prior Japanese Patent Application No. 2021-113611, filed on Jul. 8, 2021, the entire contents of which are incorporated herein by reference.

### FIELD

The embodiment discussed herein is related to an information processing apparatus, an information processing method, and an information processing program.

### BACKGROUND

There is a cluster-type computing system in which a plurality of computers is integrated and operated as one system in order to obtain high processing performance. Each computer included in the cluster-type system may be referred to as a computing node. Examples of the cluster-type system include a supercomputer in a field of high-performance computing (HPC).

Japanese Laid-open Patent Publication No. 2012-215933 and Japanese Laid-open Patent Publication No. 2013-210683 are disclosed as related art.

### SUMMARY

According to an aspect of the embodiments, an information processing apparatus includes: a memory; and a processor coupled to the memory and configured to: divide a job in units of computing nodes for a plurality of computing nodes; determine execution of scale-out or scale-in on the basis of a load in a case where each of the computing nodes is caused to execute a job obtained by the division; execute, in a case where determining execution of the scale-out, the scale-out according to the division of the job in units of computing nodes; and execute, in a case where determining execution of the scale-in, the scale-in according to the division of the job in units of computing nodes.

The objective and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a system configuration diagram of a cluster-type system according to an embodiment;

FIG. 2 is a block diagram of a leader node;

FIG. 3 is a diagram illustrating an outline of job management by the leader node;

FIG. 4 is a diagram for describing job division;

FIG. 5 is a diagram illustrating an example of job scheduling by backfill;

FIG. 6 is a diagram for describing a method for calculating an upper limit value of a job execution time;

FIG. 7 is a diagram illustrating a transition of internode communication at a time of scale-out;

FIG. 8 is a flowchart of job execution processing by the cluster-type system according to the embodiment;

FIG. 9 is a flowchart of job scale-in and scale-out processing by the cluster-type system according to the embodiment;

FIG. 10 is a diagram illustrating comparison of usage charges in a case where a job is executed; and

FIG. 11 is a hardware configuration diagram of a computing node.

### DESCRIPTION OF EMBODIMENTS

In such a cluster-type system, a plurality of people may share one system. In the cluster-type system shared by a plurality of people, there are two types of user accounts: system users and system administrators. The user describes contents desired to be processed on the system as a job, and inputs the job to the system. The job indicates which program is executed and how much computing resources are needed for the program. The computing node to which the job is deployed is determined by a job scheduler operating on the cluster-type system. Then, a computing node group to which the jobs on the system are deployed executes the jobs according to the description contents of the input job.

Furthermore, there is an single program multiple data (SPMD) model as one of execution forms of a program that performs large-scale processing in the cluster-type system. In SPMD, all processes execute the same program. Furthermore, a processing range for which each process is responsible is divided. There are two general methods for dividing the processing range: data parallelism and task parallelism. The data parallelism is a division method in which data to be processed is divided and allocated to each process. The task parallelism is a division method in which division for each function to be processed and allocation to each process are performed. As the division for each function to be processed, for example, division for each type of functions may be considered. In a case where a program is executed in SPMD, communication occurs between each process for information sharing.

Moreover, in the cluster-type system, there is a case where scale-in or scale-out is performed after starting execution of a job. For example, a case may be considered where the number of computing nodes to be used changes due to fluctuations in a workload. In a case where a usage charge changes depending on the number of computing nodes to be used, it is possible to improve processing capacity by reducing the number of computing nodes to be used by scale-in when the workload is low, or by increasing the number of computing nodes to be used by scale-out when the workload is high.

As the shared system, there is also a cloud-type computing system (infrastructure as a service) as a system having a configuration similar to that of the cluster-type system. In the cluster-type system, the objective is often use of special resources such as a supercomputer by a professional user. However, in the cloud-type system, the objective is often use of a general machine by a general user. Here, in the cloud-type system or the cluster-type system, a usage charge may be determined according to computing resources to be used. For example, the usage charge is determined by a type and the number of machines to be used.

In this regard, in the cloud-type system, a user side has authority to determine whether or not to use each computing node, so that the user may manage reduction or increase of computing nodes by using a console, and the user may control scale-in or scale-out. On the other hand, in the cluster-type system, since the authority to determine whether or not to use each computing node is rarely given to a user side and modification of a job after input by the user is not accepted, it is difficult for the user to control scale-in or scale-out.

Thus, in the prior art, in the cluster-type system, in a case where a workload fluctuates, a computing node is secured in advance according to a predicted maximum resource amount, and a job is caused to be executed.

Furthermore, as a technology related to the shared system, there is a technology in which, in the cluster-type system, an unused space satisfying resources requested by an input job is retrieved from a scheduler map and a space in which execution may be started earliest is allocated. In addition, there is a technology in which, in the cloud-type system, a master node that manages a task executed by each worker node determines whether it is possible to prepare a worker node that may complete processing within a due date for a task requested to be processed, and performs scale-out in a case where the preparation is not possible.

However, in the case where a computing node is secured in advance according to a predicted maximum resource amount, a large surplus resource is generated when the workload becomes low. Because an overall actual utilization rate of the system is lowered, it is difficult to improve processing performance of the cluster-type system.

Furthermore, in the technology in which, in the cluster-type system, an unused space satisfying resources requested by an input job is retrieved from a scheduler map, it is difficult to manage scale-in or scale-out. Moreover, in the technology in which a master node determines whether it is possible to prepare a worker node that may complete processing within a due date and performs scale-out, communication between tasks is not assumed, and it is difficult to apply the technology to management of scale-in or scale-out in SPMD.

The disclosed technology has been made in view of the above, and an objective thereof is to provide an information processing apparatus, an information processing method, and an information processing program that improve processing performance of a shared system.

Hereinafter, an embodiment of an information processing apparatus, an information processing method, and an information processing program disclosed in the present application will be described in detail with reference to the drawings. Note that the following embodiment does not limit the information processing apparatus, the information processing method, and the information processing program disclosed in the present application.

### Embodiment

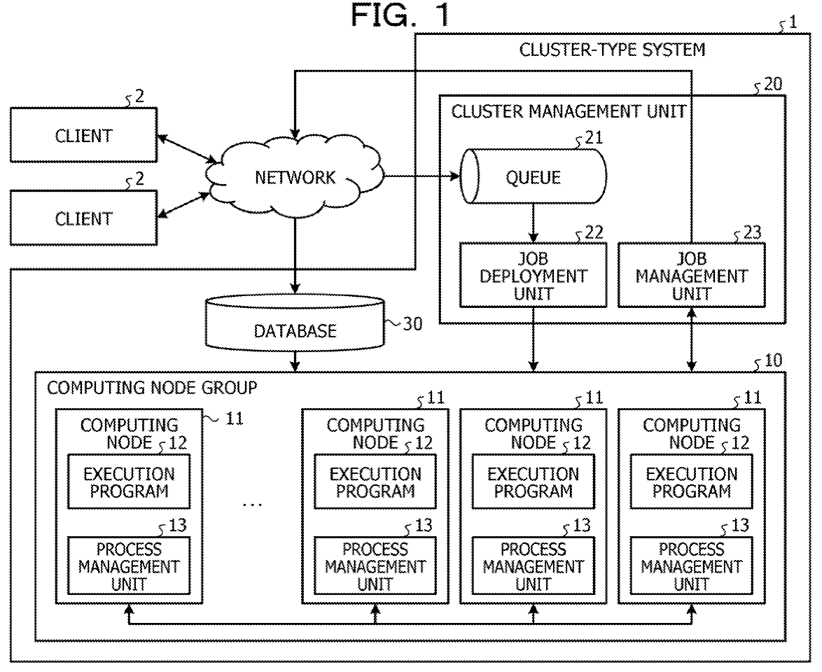

FIG. 1 is a system configuration diagram of a cluster-type system according to an embodiment. A cluster-type system 1 is connected to a plurality of clients 2 via a network. There is no limit to the number of clients 2. In the present embodiment, a case will be described where a user is charged by the number of computing nodes 11 to be used when the user submits a job to be executed to the cluster-type system 1. For example, one computing node used for the job is a charging unit.

The client 2 is a terminal device operated by a user of the cluster-type system 1. The user operates the client 2 to transmit a job deployment request including information regarding a job desired to be executed and data to be processed that is used in the job to the cluster-type system 1 via the network. The job deployment request includes, for example, an initial value of a resource amount to be used for execution of a job and a program. Thereafter, the client 2 receives a job execution result from the cluster-type system 1 via the network.

As illustrated in FIG. 1, the cluster-type system 1 includes a computing node group 10, a cluster management unit 20, and a database 30.

The database 30 receives, in the form of stream data, an input of data to be processed included in job deployment information transmitted from the client 2. The database 30 stores the acquired data to be processed.

The cluster management unit 20 integrally manages processing of jobs. The cluster management unit 20 includes a queue 21, a job deployment unit 22, and a job management unit 23.

The queue 21 receives an input of a job deployment request transmitted from the client 2. The queue 21 arranges and stores a job input from each client 2 in order of input. Then, the queue 21 outputs each job in order to the job deployment unit 22 on a first-in, first-out basis.

The job deployment unit 22 manages execution of a job. For example, the job deployment unit 22 determines execution of the next job from a state of a job that is already being executed. Next, the job deployment unit 22 acquires the next job deployment request from the queue 21. Next, the job deployment unit 22 acquires information regarding the job included in the job deployment request. Thereafter, the job deployment unit 22 outputs the information regarding the job to be executed to the computing node group 10.

The job management unit 23 monitors states of jobs to be executed by the computing node group 10. Then, the job management unit 23 performs abnormality detection and notification of a job, control of retry of a job, transmission of a processing result of a completed job to the client 2, and the like.

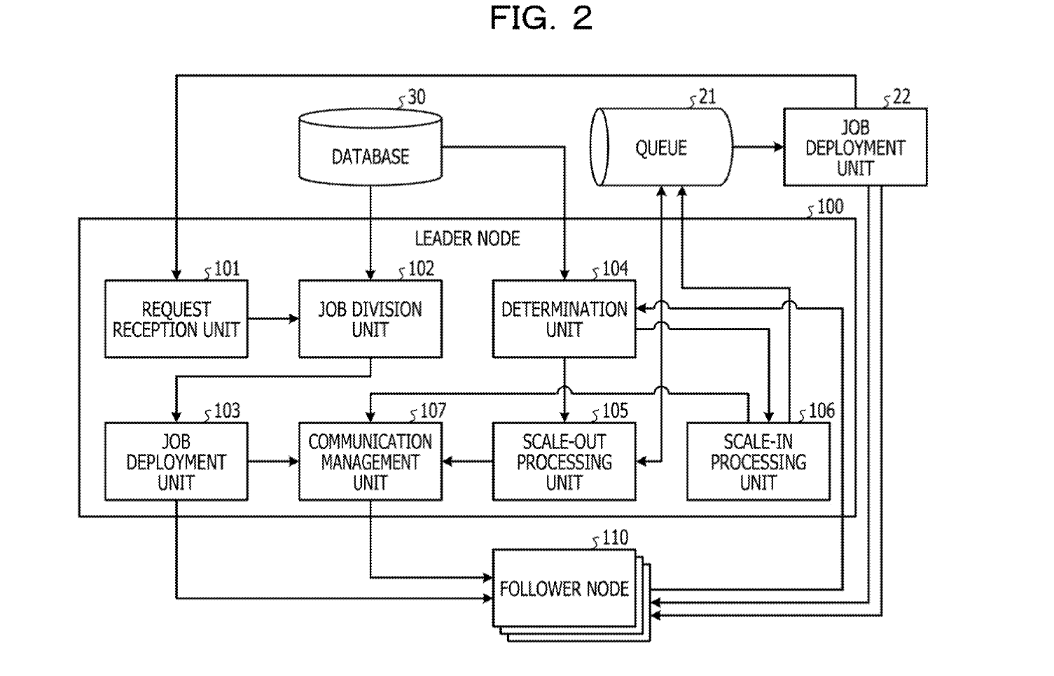

The computing node group 10 executes jobs input from the job deployment unit 22 by using data to be processed that is stored in the database 30. The computing node group 10 includes a plurality of the computing nodes 11. Hereinafter, details of execution of a job by each computing node 11 included in the computing node group 10 according to the present embodiment will be described. FIG. 2 is a block diagram of a leader node.

One of the computing nodes 11 included in the computing node group 10 is assigned as a leader node 100, and another computing node 11 becomes a follower node 110. Which computing node 11 is set as the leader node 100 may be specified in advance by an administrator of the cluster-type system 1, or one of the computing nodes 11 may also be randomly selected when a job is executed. The leader node 100 performs job division, job deployment to the follower node 110, execution of scale-in and scale-out, and the like. Furthermore, the leader node 100 may also execute a job obtained by the division in a similar manner to the follower node 110. The follower node 110 executes a job deployed to its own device by the leader node 100. The computing nodes 11 including the leader node 100 and the follower node 110 execute jobs while communicating with each other.

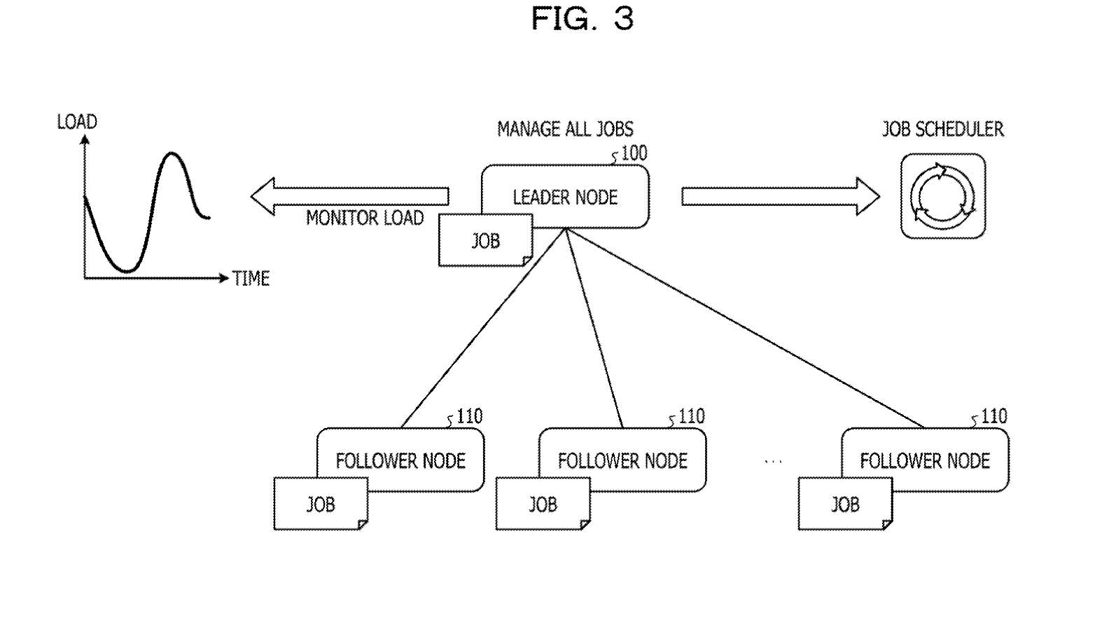

FIG. 3 is a diagram illustrating an outline of job management by the leader node. The leader node 100 divides a job to be executed, allocates the divided jobs to a plurality of the follower nodes 110, and causes the follower nodes 110 to execute the jobs. Thereafter, the leader node 100 monitors a load of each of the jobs executed by the follower nodes 110. Then, the leader node 100 determines execution of scale-out or scale-in according to the load. Thereafter, the leader node 100 operates as a job scheduler that controls execution of a specific job, divides the job to perform scale-in or scale-out, and causes each of the follower nodes 110 corresponding to one job to execute the job after the division.

Returning to FIG. 2, details of the function of the job management of the leader node 100 will be described. As illustrated in FIG. 2, the leader node 100 includes a request reception unit 101, a job division unit 102, a job deployment unit 103, a determination unit 104, a scale-out processing unit 105, a scale-in processing unit 106, and a communication management unit 107.

The request reception unit 101 acquires an input of information regarding a job to be executed from the job deployment unit 22 of the cluster management unit 20. Then, the request reception unit 101 outputs the acquired job to the job division unit 102.

The job division unit 102 receives an input of a job to be executed from the request reception unit 101. Then, the job division unit 102 divides the acquired job by the number of computing nodes 11 specified as resources to be used. For example, the job division unit 102 divides a job in units of computing nodes.

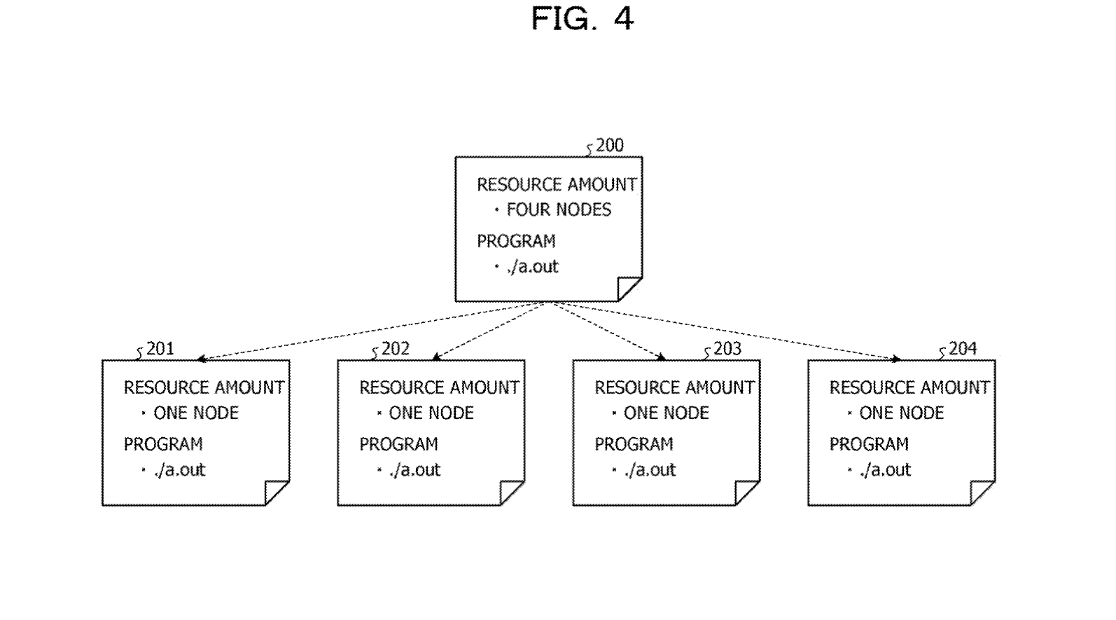

FIG. 4 is a diagram for describing job division. For example, a case will be described where the job division unit 102 acquires the job 200 in FIG. 4 as a job to be executed. In FIG. 4, in order to represent a state of each of the jobs 200 to 204, a resource amount and a program are described as the respective pieces of information in each of the jobs 200 to 204.

Here, the information regarding the job 200 includes a resource amount to be used and a program. Thus, the job division unit 102 acquires information such as using four computing nodes 11 as the resource amount to be used from the information regarding the job 200. Next, the job division unit 102 divides the job 200 into four jobs 201 to 204 so as to be allocated to the four computing nodes 11. Each of these jobs 201 to 204 is the resource amount used by one computing node 11, and a program to be executed is allocated to each of the jobs 201 to 204. Then, each of the jobs 201 to 204 is executed by different computing nodes 11.

The job division unit 102 outputs jobs obtained by the division and information regarding the jobs to the job deployment unit 103. Then, the job division unit 102 requests the job deployment unit 103 to perform job deployment.

Here, in the present embodiment, the job division unit 102 included in the leader node 100 performs division at a time of inputting a job, but job division may also be performed at another timing. For example, a user may also divide a job to be executed by the cluster-type system 1 in advance before the job is input, and input jobs obtained by the division to the cluster-type system 1. In this case, the job division unit 102 does not have to perform the job division.

The job deployment unit 103 receives an input of jobs obtained by division and information regarding the jobs with a job deployment request from the job division unit 102. Then, from the information regarding the jobs, the job deployment unit 103 confirms the number of computing nodes 11 to be used. Thereafter, the job deployment unit 103 secures the follower nodes 110 that execute the jobs from the computing nodes 11. At this time, the job deployment unit 103 secures the same number of follower nodes 110 as the number of the divided jobs. Here, the job deployment unit 103 may secure the computing nodes 11 other than the leader node 100 as the follower nodes 110 to be secured, or may also secure the leader node 100 as one of the follower nodes 110. The follower node 110 corresponds to an example of a “job execution node”.

Next, the job deployment unit 103 acquires an address for communication of each of the secured follower nodes 110. Then, the job deployment unit 103 outputs the address of each of the follower nodes 110 that are caused to execute the jobs to the communication management unit 107.

Thereafter, the job deployment unit 103 deploys one of the jobs obtained by the division to each of the secured follower nodes 110. Then, the job deployment unit 103 causes the follower nodes 110 to which the jobs are deployed to execute the deployed jobs.

The determination unit 104 acquires a load of each job obtained by division, which is to be executed by each follower node 110, at a predetermined cycle. Then, the determination unit 104 calculates a load of the entire jobs based on the load of each job obtained by the division, and determines whether or not to perform scale-out or scale-in.

In a case where scale-out is performed, the determination unit 104 instructs the scale-out processing unit 105 to perform the scale-out with the increased number of follower nodes 110. On the other hand, in a case where scale-in is performed, the determination unit 104 instructs the scale-in processing unit 106 to execute the scale-in with the decreased number of follower nodes 110.

The determination unit 104 determines execution of scale-in or scale-out as follows. For example, the determination unit 104 acquires a throughput of each divided job, which is to be executed by each follower node 110, as a load. Then, the determination unit 104 calculates, as a load of the entire jobs, an average throughput per job obtained by the division from throughputs of the divided jobs. Here, it is assumed that there are N follower nodes 110, and throughputs of divided job, each of which is executed by one of the N follower nodes 110, are _{T}0 to _{T}N-1. In this case, the determination unit 104 calculates an average throughput per job obtained by the division by using the following Expression (1).

$$τ = \frac{\sum {}_{i = 0}^{N - 1} {τ}_{i}}{N}$$

...(1)

Next, the determination unit 104 acquires an amount of unprocessed data in the database 30. The amount of unprocessed data is a data amount obtained by excluding processed data from an amount of data to be processed stored in the database 30. Then, the determination unit 104 determines the number of follower nodes 110 that are caused to execute the jobs by obtaining the number of jobs that satisfy a target time serving as a threshold for a time from when data is input to the database 30 until the input data is processed. The determination unit 104 determines to perform the scale-out in a case where the number of follower nodes 110 that are caused to execute the jobs increases, and determines to perform the scale-in in a case where the number of follower nodes 110 that are caused to execute the jobs decreases.

The determination unit 104 according to the present embodiment obtains the number of divisions in a case where unprocessed data included in a job is divided in units of computing nodes, determines increase or decrease in the number of divisions, and determines to perform scale-out or scale-in. By acquiring a data amount of unprocessed data to be used in an unprocessed job and performing division so that a processing time of the acquired data amount satisfies a predetermined target time, the determination unit 104 according to the present embodiment obtains the number of divisions in a case where the unprocessed job is divided in units of computing nodes.

For example, scale-in and scale-out will be described assuming that a cycle is Tc, an average throughput is _{T}, an amount of unprocessed data is D, and a target time is Tw. Here, it is assumed that the number of jobs obtained by division, which are to be executed by the follower nodes 110, before scale-in and scale-out are executed is 4.

The determination unit 104 monitors throughputs of the follower nodes 110 and calculates the average throughput _{T} per the cycle Tc as 50. In this case, a throughput of the entire follower nodes 110 is 4_{T} = 200. Moreover, the determination unit 104 confirms that the amount of unprocessed data is D = 1000. At this time, in a case where the target time Tw is 10 cycles, or 10 Tc, the determination unit 104 calculates the minimum number of jobs satisfying Tw as D/10_{T} = 2. Therefore, the determination unit 104 determines that the number of jobs obtained by the division, which are to be executed by the follower nodes 110, may be scaled in to 2. In this case, the determination unit 104 instructs the scale-in processing unit 106 to perform scale-in.

Similarly, the determination unit 104 monitors throughputs of the follower nodes 110 and calculates the average throughput _{T} per the cycle Tc as 50. In this case, a throughput of the entire follower nodes 110 is 4_{T} = 200. Moreover, the determination unit 104 confirms that the amount of unprocessed data is D = 4000. At this time, in a case where the target time Tw is 10 cycles, or 10 Tc, the determination unit 104 calculates the minimum number of jobs satisfying Tw as D/10_{T} = 8. Therefore, the determination unit 104 determines that the number of jobs obtained by the division, which are to be executed by the follower nodes 110, is preferably scaled out to 8. In this case, the determination unit 104 instructs the scale-out processing unit 105 to perform scale-out.

Here, in the present embodiment, it is determined whether or not to perform scale-out or scale-in by obtaining the number of computing nodes 11 to be used by using the amount of unprocessed data and the target time. However, as long as resources to be used may be determined according to a load, another method may also be used. For example, the determination unit 104 calculates a load of the entire jobs for each unit time. Then, the determination unit 104 determines that scale-out is performed when the load calculated this time is equal to or greater than a predetermined scale-out threshold compared to a load at a previous time. Furthermore, the determination unit 104 determines that scale-in is performed when the load calculated this time is equal to or smaller than a predetermined scale-in threshold compared to a load at a previous time. Even in such a method, the determination unit 104 may determine to perform scale-out and scale-in.

The scale-out processing unit 105 receives, from the determination unit 104, an instruction to perform scale-out with the increased number of the follower nodes 110. Then, the scale-out processing unit 105 divides a job by the specified number of follower nodes 110 after the scale-out.

For example, the scale-out processing unit 105 confirms unprocessed data stored in the database 30. Then, the scale-out processing unit 105 divides the unprocessed data by the number of follower nodes 110 after scale-out, and divides a job into jobs each of which processes one piece of unprocessed data.

Thereafter, the scale-out processing unit 105 secures the number of follower nodes 110 after the scale-out. Next, the scale-out processing unit 105 acquires an address for communication of each of the secured follower nodes 110. Next, the scale-out processing unit 105 outputs information regarding the address of each of the follower nodes 110 that are caused to execute the jobs to the communication management unit 107. Then, the scale-out processing unit 105 deploys the jobs obtained by the division to the secured follower nodes 110, and causes the follower nodes 110 to execute the jobs. That is, the scale-out processing unit 105 executes the scale-out according to the job division in units of computing nodes. The scale-out processing unit 105 adds the computing node 11 to the follower nodes 110, causes each of the follower nodes 110 to execute a job obtained by division in units of computing nodes after the addition, and perform scale-out. Here, by inputting the jobs obtained by the division to the queue 21, the scale-out processing unit 105 causes the job deployment unit 22 to deploy the jobs obtained by the division to the secured follower nodes 110, and causes each of the follower nodes to execute the deployed job.

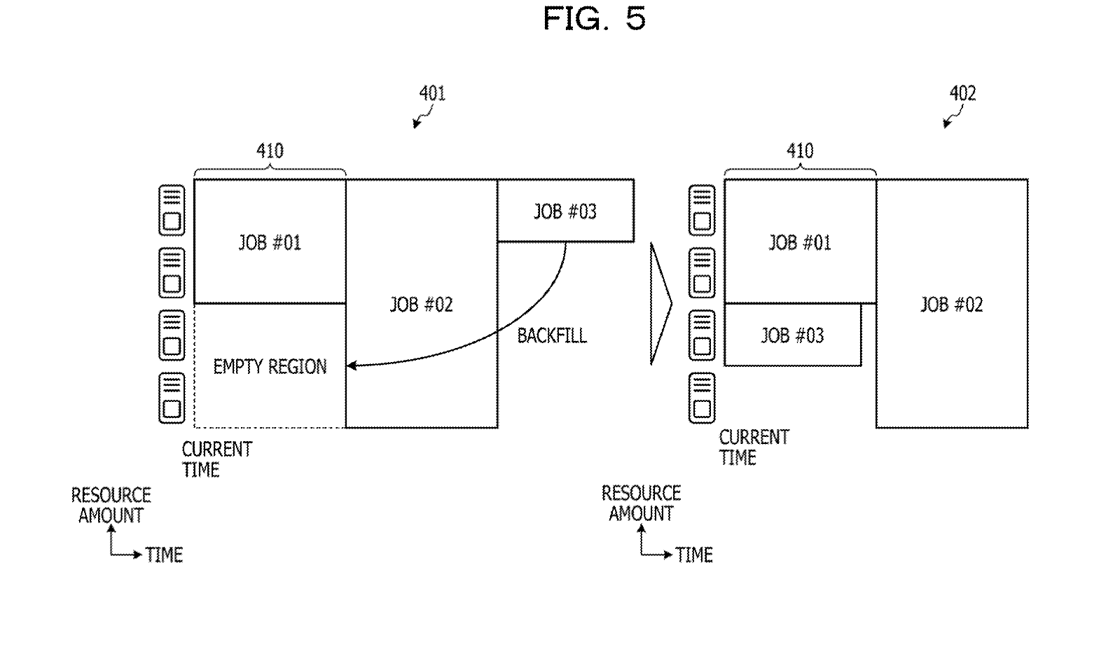

Here, the scale-out processing unit 105 according to the present embodiment performs the job deployment by using a function referred to as backfill, which is a technology for effectively using resources. FIG. 5 is a diagram illustrating an example of job scheduling by the backfill. In FIG. 5, in both states 401 and 402, a vertical axis represents a resource amount to be used by each job and a horizontal axis represents a lapse of time.

In a case where job scheduling is performed, the scale-out processing unit 105 normally deploys jobs to the follower nodes 110 on a first-in, first-out (FIFO) basis, or, in order of acquisition, and causes the follower nodes 110 to execute the jobs. Note that, depending on a job congestion status, a case may be considered where a job additionally input at a time of scale-out is not executed immediately. At this time, in a case where there is an empty follower node 110 that has not executed a job at a timing before that, the scale-out processing unit 105 creates an added job so that the backfill may be performed with high probability. For example, the scale-out processing unit 105 creates a job so that the added job is deployed to the empty follower node 110 and may be early executed by skipping the order jobs.

For example, a case will be described where, in the case of first-in, first-out, the added job is scheduled as indicated in the state 401 on the right in the paper of FIG. 5. In this case, after a job #01 is executed, a job #02 is executed, and then a job #03 is executed. Note that, in a period 410, there is a computing node 11 that has not executed a job. In addition, the number of the computing nodes 11 that have not executed a job is sufficient to execute the added job #03. Furthermore, the period 410 is time sufficient to complete the execution of the added job #03.

Thus, in the case of scheduling the job #03 added by the scale-out, the scale-out processing unit 105 performs the backfill to cause the follower nodes 110 to execute the job #03 in parallel with the job #01 during the period 410. With this configuration, the scale-out processing unit 105 may shorten a job execution waiting time.

Here, the smaller a resource amount of the added job, the higher probability it is to perform the backfill. In this regard, in the present embodiment, one job is allocated to one node. In addition, since the scale-out processing unit 105 determines whether the backfill is possible in units of the number of computing nodes 11, it may be said that the resource amount requested by one job is a minimum unit in which the backfill is performed, thus the backfill is performed with high probability.

Moreover, the scale-out processing unit 105 controls the added job as follows such that the backfill may be performed with high probability. The smaller an upper limit value of an execution time of a job, the higher probability the backfill is to be performed. Note that because it is difficult to predict an actual scheduled execution time, in a case where a job is scheduled, an upper limit execution time registered as information regarding the job is normally used.

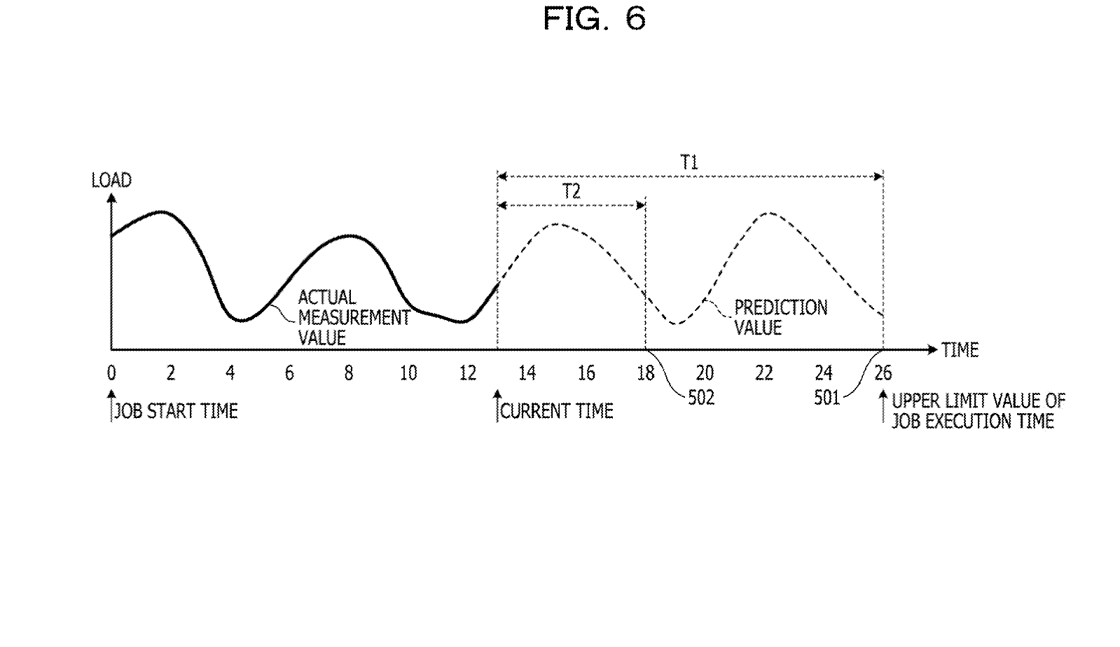

The scale-out processing unit 105 according to the present embodiment calculates an upper limit value of an execution time of a job to be added so as to reduce the upper limit value of the job execution time as much as possible in consideration of a congestion status of the queue 21 and periodicity of a load in the cluster-type system 1. FIG. 6 is a diagram for describing a method for calculating the upper limit value of the job execution time.

The scale-out processing unit 105 transmits a command inquiring about a job congestion status to the queue 21 to acquire a job congestion degree. Note that, in a case where the cluster-type system 1 does not support the command inquiring about the job congestion status, the scale-out processing unit 105 may also measure a waiting time from a job input to execution to determine the job congestion degree. In that case, the scale-out processing unit 105 determines that the job congestion degree is high when the waiting time is long.

In a case where the job congestion degree is low, the scale-out processing unit 105 calculates the upper limit value of the execution time of the added job by subtracting a current time from an end time registered as the information regarding the job. For example, the scale-out processing unit 105 subtracts the current time from a time 501 to obtain the upper limit value of the execution time of the added job. In this case, a period T1 in FIG. 6 is the upper limit value of the execution time of the added job. This is because, when the congestion degree is low, there is a high possibility that the backfill will be performed even if the execution time is taken long.

On the other hand, in a case where the job congestion degree is high, the scale-out processing unit 105 predicts how long a load increase will continue. The scale-out processing unit 105 may use time-series analysis to calculate a prediction value. As the time-series analysis, for example, an autoregressive model or a moving average model may be used. For example, in the case of FIG. 6, the scale-out processing unit 105 predicts that a load will increase until a time 502 compared to the current load. Then, the scale-out processing unit 105 subtracts the current time from the predicted time 502 to obtain the upper limit value of the execution time of the added job. For example, a period T2 in FIG. 6 is the upper limit value of the execution time of the added job. This is because, in a case where the congestion degree is high, it is considered that a time when resources are available is short, and possibility that the backfill is performed is increased by setting the upper limit value as short as possible.

In this way, the scale-out processing unit 105 determines whether there is an empty computing node capable of executing the job obtained by the division after the scale-out during the period when other jobs are executed. Then, in a case where there is the empty computing node, the scale-out processing unit 105 causes the empty computing node to execute the job obtained by the division after the scale-out during the period when other jobs are executed.

The scale-in processing unit 106 receives, from the determination unit 104, an instruction to execute scale-in with the decreased number of the follower nodes 110. Then, the scale-in processing unit 106 divides a job by the specified number of follower nodes 110 after the scale-in.

For example, the scale-in processing unit 106 confirms unprocessed data stored in the database 30. Then, the scale-in processing unit 106 divides the unprocessed data by the number of follower nodes 110 after scale-in, and divides a job into jobs each of which process one piece of unprocessed data.

Thereafter, the scale-in processing unit 106 secures the number of follower nodes 110 after the scale-in. Next, the scale-in processing unit 106 acquires an address for communication of each of the secured follower nodes 110. Next, the scale-in processing unit 106 outputs information regarding the address of each of the follower nodes 110 that are caused to execute the jobs to the communication management unit 107. Then, the scale-in processing unit 106 deploys the jobs obtained by the division to the secured follower nodes 110, and causes the follower nodes 110 to execute the jobs. That is, the scale-in processing unit 106 performs the scale-in according to the job division in units of computing nodes. The scale-in processing unit 106 reduces the computing nodes 11 from the follower nodes 110, and causes each of the follower nodes 110 to execute a job obtained by division in units of computing nodes after the reduction. Here, by inputting the jobs obtained by the division to the queue 21, the scale-in processing unit 106 causes the job deployment unit 22 to deploy the jobs obtained by the division to the secured follower nodes 110, and causes each of the follower nodes to execute the deployed job.

Here, job division at the time of scale-out and scale-in will be described in detail. The scale-out will be described as an example. The scale-out processing unit 105 confirms {dᵢ, dᵢ₊₁, ..., dⱼ} as unprocessed data. Then, assuming that the number of follower nodes 110 to be used after the scale-out is N′, the scale-out processing unit 105 divides {dᵢ, dᵢ₊₁, ..., dⱼ} by N′. Then, the scale-out processing unit 105 sets data to be used in a first job as {dᵢ, dᵢ₊₁, ..., d_{r(j+1-i)/N′)-1}}. Furthermore, the scale-out processing unit 105 sets data to be used in a second job as {d_{r((j+1-i)/N′)}, ..., d_{2r((j+1-i)/N-1}}. By repeating this, the scale-out processing unit 105 sets data to be used in an N′th job as {d_{(N′-1)r((j+1-i)/N)}, ..., dj}. Here, r(x) is a function that rounds off a real number x greater than 0 to obtain an integer. The scale-out processing unit 105 divides a job into jobs that execute these divided pieces of unprocessed data, deploys the jobs to the follower nodes 110, and causes the follower nodes 110 to execute the jobs. The above job division processing is similar in the case of scale-in.

The communication management unit 107 receives, at a start of execution of a specific job, an input of information regarding an address for communication of each of the follower nodes 110 that are caused to execute the specific job from the job deployment unit 103. Next, the communication management unit 107 generates an address table for communication in the specific job, in which the addresses of the follower nodes 110 that are caused to execute the specific job are registered. Then, the communication management unit 107 transmits the generated address table for communication in the specific job to all the follower nodes 110 that execute the specific job. With this configuration, communication may be performed between the follower nodes 110 that execute the specific job based on the address table for communication in the specific job, and the job may be executed.

Thereafter, at a time of scale-out of the specific job, the communication management unit 107 receives, from the scale-out processing unit 105, an input of information regarding an address for communication of each of the follower nodes 110 that are caused to execute the specific job after the scale-out. Next, the communication management unit 107 registers the addresses of the follower nodes 110 that are caused to execute the specific job after the scale-out, and updates the address table for communication in the specific job. Then, the communication management unit 107 transmits the updated address table for communication in the specific job to all the follower nodes 110 that execute the specific job after the scale-out. With this configuration, even after the scale-out, communication may be performed between the follower nodes 110 that execute the specific job based on the address table, and the job may be executed.

Furthermore, at a time of scale-in of the specific job, the communication management unit 107 receives, from the scale-in processing unit 106, an input of information regarding an address for communication of each of the follower nodes 110 that are caused to execute the specific job after the scale-in. Next, the communication management unit 107 registers the addresses of the follower nodes 110 that are caused to execute the specific job after the scale-in, and updates the address table for communication in the specific job. Then, the communication management unit 107 transmits the updated address table for communication in the specific job to all the follower nodes 110 that execute the specific job after the scale-in. With this configuration, even after the scale-in, communication may be performed between the follower nodes 110 that execute the specific job based on the address table, and the job may be executed.

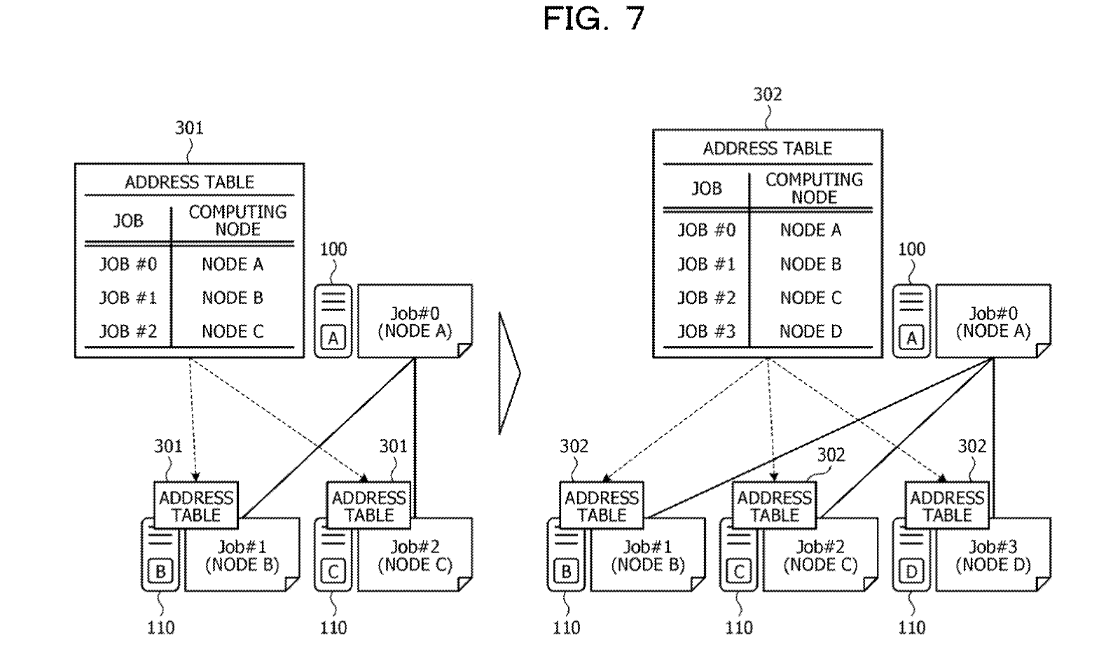

FIG. 7 is a diagram illustrating a transition of communication between nodes at the time of scale-out. Here, an example of management of communication between nodes at the time of scale-out will be described by referring FIG. 7. A case will be described where a job is processed with the leader node 100 as also one of the follower nodes 110.

The communication management unit 107 of the leader node 100 causes, at a start of execution of a job, two follower nodes 110 including its own node to communicate by using an address table 301. Here, it is assumed that the leader node 100 is a node A, and the two follower nodes 110 are nodes B and C.

In this case, since the job is executed by the nodes A to C as the computing nodes 11, addresses of the nodes A to C are registered in the address table 301. Here, the communication management unit 107 generates the address table 301 in which the respective addresses of the nodes A to C that execute jobs are registered for each job. In this case, there are three jobs #0 to #2; the job #0 is executed by the node A, the job #1 is executed by the node B, and the job #2 is executed by the node C. Then, the address table 301 is transmitted to the node B and the node C.

Thereafter, scale-out occurs, the job is divided into the jobs #0 to #3 and scaled out by the scale-out processing unit 105, and a node D is added as an additional follower node 110. In this case, the communication management unit 107 creates an address table 302 in which the nodes A to D corresponding to the jobs #0 to #3 are registered. Then, the communication management unit 107 transmits the address table 302 to the nodes B to D to cause the nodes B to D to perform communication.

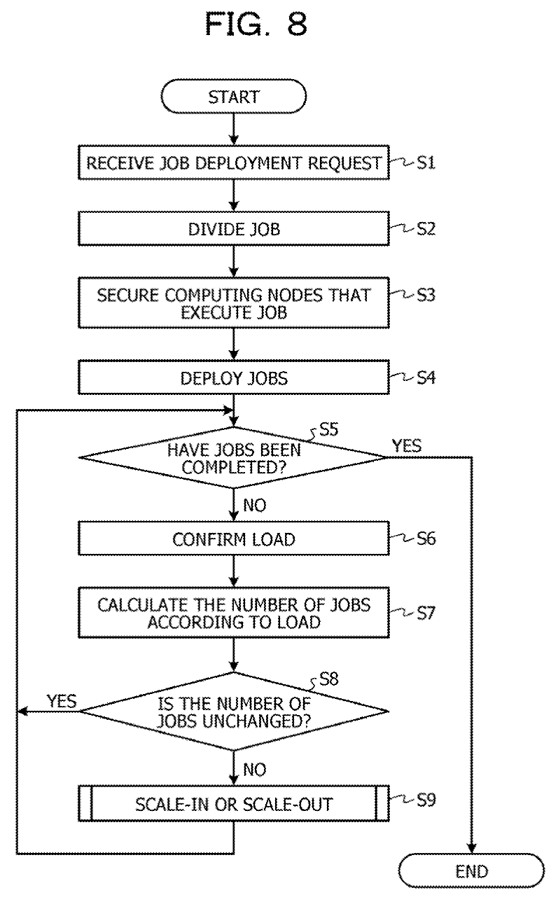

FIG. 8 is a flowchart of job execution processing by the cluster-type system according to the embodiment. Next, a flow of the job execution processing by the cluster-type system 1 according to the embodiment will be described by referring FIG. 8.

The request reception unit 101 receives a job deployment request from the job deployment unit 22 of the cluster management unit 20 (Step S1). Then, the request reception unit 101 outputs the job deployment request to the job division unit 102.

The job division unit 102 receives an input of the job deployment request from the request reception unit 101. Next, the job division unit 102 acquires the number of computing nodes 11 to be used, which is specified in information regarding a job included in the job deployment request. Moreover, the job division unit 102 acquires data to be processed from the database 30. Then, the job division unit 102 divides the job into the number of computing nodes 11 to be used to execute the job (Step S2). Thereafter, the job division unit 102 outputs jobs obtained by the division to the job deployment unit 103.

The job deployment unit 103 receives an input of the jobs obtained by the division from the job division unit 102. Next, the job deployment unit 103 secures the same number of computing nodes 11 as the number of the jobs obtained by the division (Step S3).

Then, the job deployment unit 103 deploys one job to each of the secured computing nodes 11 and causes the computing nodes 11 to execute the jobs (Step S4).

The determination unit 104 of the leader node 100 determines whether the jobs have been completed (Step S5).

In a case where the jobs have not been completed (Step S5: No), the determination unit 104 confirms a load of the follower nodes 110 that execute the jobs (Step S6).

Next, the determination unit 104 calculates the number of jobs according to the load (Step S7).

Next, the determination unit 104 determines whether the number of jobs is unchanged (Step S8). In a case where the number of jobs is unchanged (Step S8: Yes), the job execution processing returns to Step S5.

On the other hand, in a case where the number of jobs changes (Step S8: No), the determination unit 104 instructs the scale-out processing unit 105 to perform scale-out or instructs the scale-in processing unit 106 to perform scale-in, according to the change in the number of jobs. The scale-out processing unit 105 or the scale-in processing unit 106 receives the instruction from the determination unit 104, and performs scale-out or scale-in (Step S9). Thereafter, the job execution processing returns to Step S5.

On the other hand, in a case where the jobs have been completed (Step S5: Yes), the leader node 100 ends the job execution processing.

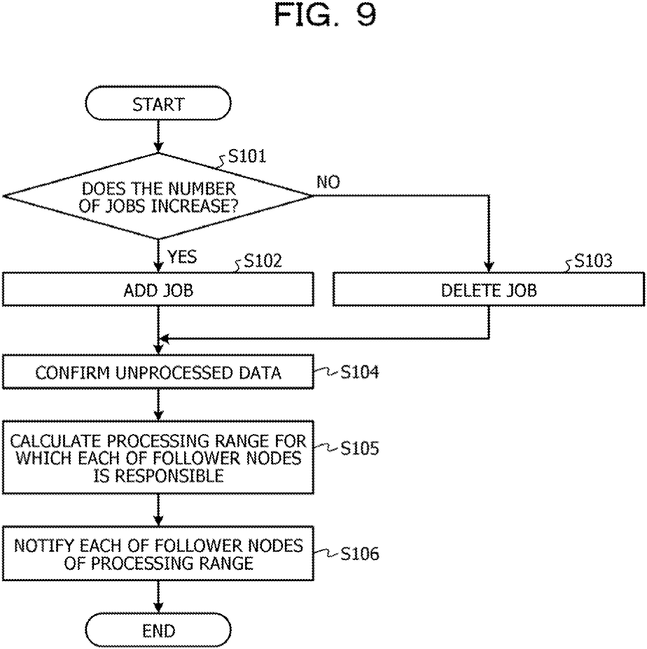

FIG. 9 is a flowchart of job scale-in and scale-out processing by the cluster-type system according to the embodiment. Next, a flow of the job scale-in and scale-out processing by the cluster-type system 1 according to the embodiment will be described by referring FIG. 9. The flow illustrated in FIG. 9 corresponds to an example of the processing performed in Steps S9 in FIG. 8.

The determination unit 104 determines whether the number of jobs increases (Step S101).

In a case where the number of jobs increases (Step S101: Yes), the determination unit 104 determines addition of a job and instructs the scale-out processing unit 105 to perform scale-out (Step S102).

On the other hand, in a case where the number of jobs does not increase (Step S101: No), the determination unit 104 determines deletion of a job and instructs the scale-in processing unit 106 to perform scale-in (Step S103).

The scale-out processing unit 105 or the scale-in processing unit 106 confirms a data amount of unprocessed data stored in the database 30 (Step S104).

Next, the scale-out processing unit 105 or the scale-in processing unit 106 calculates, for the unprocessed data, a processing range for which each of the follower nodes 110 is responsible (Step S105). For example, the scale-out processing unit 105 divides the data amount of the unprocessed data by the number of follower nodes 110 after the scale-out to obtain the processing range.

Thereafter, the scale-out processing unit 105 or the scale-in processing unit 106 secures the follower nodes 110 that are caused to execute jobs obtained by the division. Then, the scale-out processing unit 105 or the scale-in processing unit 106 notifies the secured follower nodes 110 of the processing ranges and allocates the jobs obtained by the division one by one to the follower nodes 110 (Step S106).

As described above, in the cluster-type system according to the present embodiment, a job is divided in units of computing nodes, and scale-in or scale-out of the job is performed. Moreover, addresses of computing nodes that execute the jobs are collectively managed by the leader node to implement communication between processes. With this configuration, scale-in and scale-out are possible even in a cluster-type system environment where it is difficult to modify input jobs, and it is possible to secure an optimum computing resource amount according to workload specification. Furthermore, a utilization rate of the entire system is improved by reduction of surplus resources. Therefore, it is possible to improve processing capacity of the cluster-type system.

Furthermore, even in a cluster environment where job management is restricted such that a usage charge is determined according to a use resource amount, it is possible to suppress excessive expenditure of the usage charge.

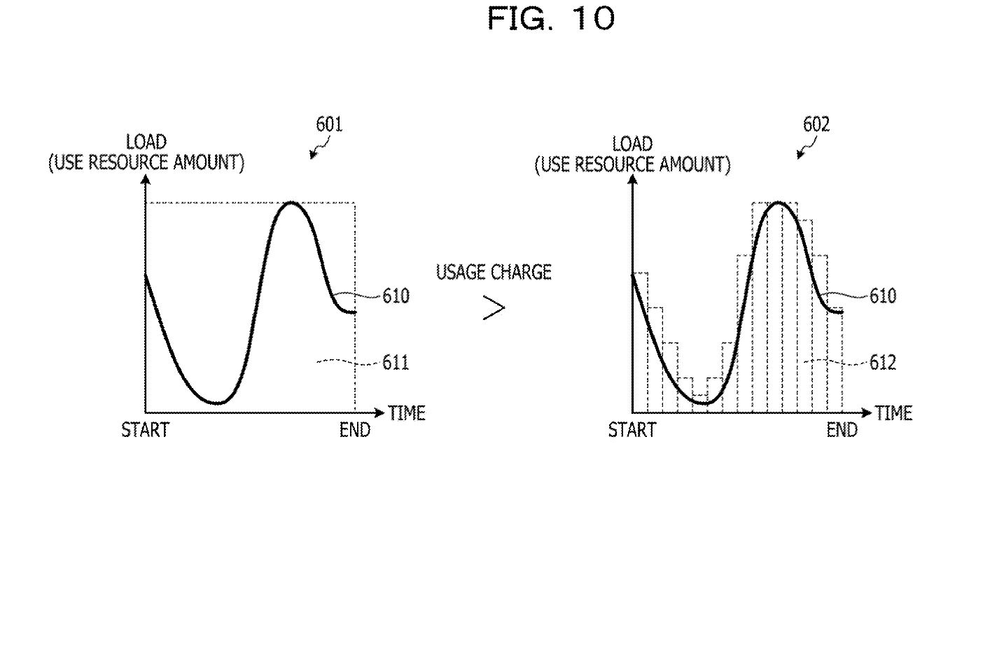

FIG. 10 is a diagram illustrating comparison of usage charges in a case where a job is executed. A graph 601 represents a usage charge in a case where the maximum resource amount is predicted and resources are secured based on the prediction in advance. A graph 602 represents a usage charge in a case where a job is executed by using the cluster-type system according to the present embodiment. In both the graphs 601 and 602, a vertical axis represents a load and a use resource amount, and a horizontal axis represents a time. Curves 610 in the graphs 601 and 602 represent the load.

As illustrated in the graph 601, in the case where the maximum resource amount is predicted and the resources are secured based on the prediction in advance, change in the use resource amount does not occur according to the change in the load, and the use resource amount is constant regardless of the change in the curve 610. Thus, with respect to the usage charge in this case, a value obtained by multiplying the usage charge in the maximum resource amount by the usage time becomes a total usage charge at the time of execution of the job, and may be regarded as equivalent to a region 611 on the graph 601.

On the other hand, in a case where the use resource amount is changed according to the load as in the present embodiment, the use resource amount is reduced in a case where the load represented by the curve 610 is low, and the use resource amount is increased in a case where the load is high. The total usage charge at the time of execution of the job in this case is a value obtained by integrating the usage charges according to the use resource amount that changes according to the load, and may be regarded as equivalent to a region 612 on the graph 602.

In this case, an area of the region 612 is smaller than an area of the region 611. That is, in a case where a job is executed by using the cluster-type system 1 according to the present embodiment, a usage charge reflecting a load at each time is incurred according to optimum resources, and it is possible to suppress the usage charge compared to a case where a maximum resource amount is predicted and resources are secured based on the prediction in advance.

### Hardware Configuration

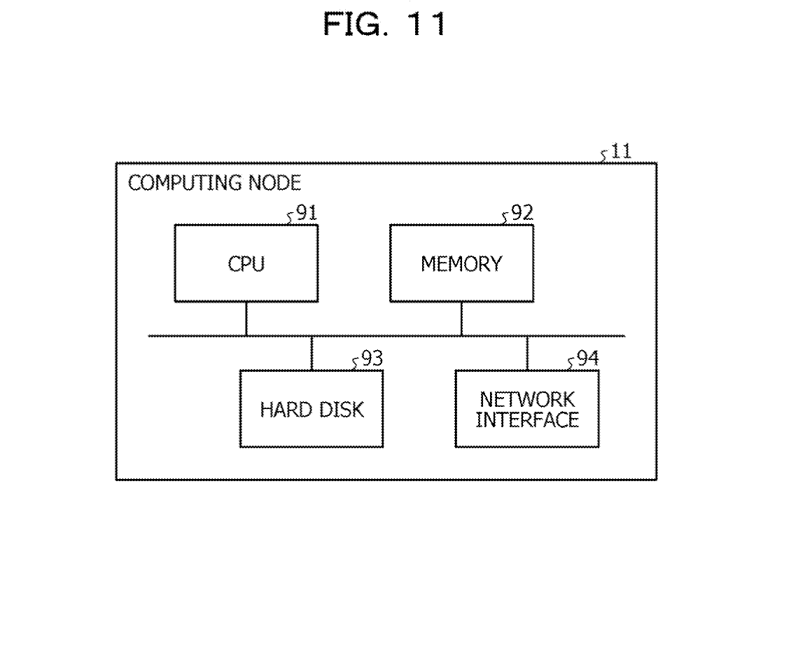

FIG. 11 is a hardware configuration diagram of the computing node. Next, a hardware configuration of the computing node 11 according to the present embodiment will be described by referring FIG. 11.

As illustrated in FIG. 11, the computing node 11 includes a central processing unit (CPU) 91, a memory 92, a hard disk 93, and a network interface 94. The CPU 91 is connected to the memory 92, the hard disk 93, and the network interface 94 via a bus.

The network interface 94 is an interface for communication between the computing node 11 and an external device. For example, in the case of the leader node 100, the network interface 94 relays communication between the CPU 91, the cluster management unit 20, and the database 30.

The hard disk 93 is an auxiliary storage device. The hard disk 93 stores, for example, an execution program 12 for executing a job, which is exemplified in FIG. 1. Furthermore, the hard disk 93 stores various programs including a program having a function for implementing a process management unit 13 exemplified in FIG. 1. Furthermore, in the case of the leader node 100, the hard disk 93 stores a program for implementing the functions of the request reception unit 101, the job division unit 102, the job deployment unit 103, and the determination unit 104 exemplified in FIG. 2. Moreover, in the case of the leader node 100, the hard disk 93 stores a program for implementing the functions of the scale-out processing unit 105, the scale-in processing unit 106, and the communication management unit 107 exemplified in FIG. 2.

The memory 92 is a primary storage device. As the memory 92, for example, a dynamic random access memory (DRAM) may be used.

The CPU 91 reads out various programs from the hard disk 93, and deploys the programs on the memory 92 to execute the programs. With this configuration, the CPU 91 may execute a job. Furthermore, the CPU 91 may implement the process management unit 13 exemplified in FIG. 1. Moreover, in the case of the leader node 100, the CPU 91 implements the functions of the request reception unit 101, the job division unit 102, the job deployment unit 103, the determination unit 104, the scale-out processing unit 105, the scale-in processing unit 106, and the communication management unit 107 exemplified in FIG. 2.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
divide a job in units of computing nodes for a plurality of computing nodes;
determine execution of scale-out or scale-in on the basis of a load in a case where each of the computing nodes is caused to execute a job obtained by the division;
execute, in a case where determining execution of the scale-out, the scale-out according to the division of the job in units of computing nodes; and
execute, in a case where determining execution of the scale-in, the scale-in according to the division of the job in units of computing nodes.

2. The information processing apparatus according to claim 1, wherein the processor:
secures the plurality of computing nodes as a plurality of job execution nodes,
deploys the job obtained by the division to each of the secured job execution nodes,
causes each of the secured job execution nodes to execute the job,
adds the computing node to the plurality of job execution nodes,
causes each of the job execution nodes to execute a job obtained by division in units of computing nodes after the addition, and executes the scale-out,
reduces the computing node from the plurality of job execution nodes, and
causes each of the job execution nodes to execute a job obtained by division in units of computing nodes after the reduction.

3. The information processing apparatus according to claim 1, wherein the processor:
obtains the number of divisions in a case where unprocessed data included in the job is divided in the units of computing nodes,
determines increase or decrease in the number of divisions, and determines execution of the scale-out or the scale-in,
executes the scale-out by adding the computing nodes that corresponds to the increase in the number of divisions, and
executes the scale-in by reducing the computing nodes that corresponds to the decrease in the number of divisions.

4. The information processing apparatus according to claim 3, wherein the processor obtains, by acquiring a data amount of unprocessed data to be used in the unprocessed job and performing division such that a processing time of the acquired data amount satisfies a predetermined target time, the number of divisions in a case where the unprocessed job is divided in the units of computing nodes.

5. The information processing apparatus according to claim 1, wherein the processor manages an address of each of the computing nodes, and causes the computing nodes that execute the jobs to perform communication.

6. The information processing apparatus according to claim 1, wherein, in a case where scheduling the computing nodes to execute the jobs obtained by the division after the scale-out, when there is an empty computing node that is capable of executing the job obtained by the division after the scale-out during a period when other jobs are executed, the processor causes the empty computing node to execute the job obtained by the division after the scale-out during the period when the other jobs are executed.

7. An information processing method:
dividing, by a computer, a job in units of computing nodes for a plurality of computing nodes;
determining execution of scale-out or scale-in on the basis of a load in a case where each of the computing nodes is caused to execute a job obtained by the division;
executing, in a case where determining execution of the scale-out, the scale-out according to the division of the job in units of computing nodes; and
executing, in a case where determining execution of the scale-in, the scale-in according to the division of the job in units of computing nodes.

8. A non-transitory computer-readable recording medium storing an information processing program causing a computer to execute a processing of:
dividing, by a computer, a job in units of computing nodes for a plurality of computing nodes;
determining execution of scale-out or scale-in on the basis of a load in a case where each of the computing nodes is caused to execute a job obtained by the division;
executing, in a case where determining execution of the scale-out, the scale-out according to the division of the job in units of computing nodes; and
executing, in a case where determining execution of the scale-in, the scale-in according to the division of the job in units of computing nodes.
